(19) United States
(12) Patent Application Publication
(10) Pub. No.: US 2016/0188569 A1
(43) Pub. Date: Jun. 30, 2016

(54) Generating a Table of Contents for Unformatted Text

(71) Applicant: International Business Machines Corporation, Armonk, NY (US)

(72) Inventors: Amit P. Bohra, Pune (IN); Krishna Kummamuru, Bangalore (IN); Alexander Pikovsky, Lexington, MA (US); Abhishek Shivkumar, Bangalore (IN)

(21) Appl. No.: 15/060,789

(22) Filed: Mar. 4, 2016

Related U.S. Application Data
(63) Continuation of application No. 14/132,173, filed on Dec. 18, 2013.

(51) Int. Cl. G06F 17/27; G06F 17/30

(52) U.S. Cl. CPC G06F 17/2785; G06F 17/2745; G06F 17/30616

(57) ABSTRACT

An approach is provided for an information handling system that includes a processor and a memory to generate a table of contents pertaining to a document. The approach semantically analyzes the document to identify semantic relationships of proximate elements of the document. A number of candidate headings corresponding to a semantically related section of the document are identified and each of the candidate headings are scored. Based on the scores of each of the candidate headings, a section heading for the semantically related section of the document is selected. The selected heading is then included in the table of contents for the section of the document. The process of identifying candidate headings, scoring candidates, and selecting the section heading is repeated for other semantically related sections of the document.

### BACKGROUND OF THE INVENTION

A Table of Content (TOC) inside a document generally lists the parts of the document in the order they appear. The table of content might include a list of headers or titles of sections inside the document, and also may contain further levels inside each of the header referring to sub-sections. When textual content does not have any formatting information as part of its structure, it is a challenging task to determine which portions of its content is either a header, title, or should otherwise be included in a table of contents. Furthermore, text can appear in an unstructured manner in various scenarios, such as a result of an optical character reader (OCR) conversion, meeting notes, call center transcripts, and various documents often used inside an enterprise. In these unstructured documents, there is no indication of titles, headings, or section separators that identify the portions of the document that should be included in a table of content.

Traditional creation of a table of contents generally requires that the text in the document indicate which part of its document refers to headings and titles and should therefore be included in a table of contents. For example, table of contents generators in word processing software generate a table of contents based on the formatting information that is present inside the electronic document. While the document is being composed, the content is written according to whether it is a heading, a title, or a sub-section by choosing options present as part of the word processing software. The table of contents generator leverages this information and generates a table of contents for the document content automatically. Another example is the automatic generation of a table of contents from HTML files. HTML files include tags such as “<h1>”, “<h2>”, and the like that indicate if a content is a heading, a sub-heading or a title. Existing tools and frameworks leverage this HTML tagging information to generate a table of content based on the HTML tags found within the HTML document. A primary drawback of existing approaches, such as the examples discussed above, above is that such approaches rely upon existing indications of headers and titles in either a form of text format, or in the form of tags such as a mark-up tag in HTML. Given an unstructured text that is generated from a call transcript or a meeting note, such tools will not be able to generate the table of contents because the text upon which they work would lack such indicating information. In fact, the existing approached do not have the capability to semantically understand the document content and to determine the headings and titles that form a part of the table of contents.

### SUMMARY

An approach is provided for an information handling system that includes a processor and a memory to generate a table of contents pertaining to a document. The approach semantically analyzes the document to identify semantic relationships of proximate elements of the document. A number of candidate headings corresponding to a semantically related section of the document are identified and each of the candidate headings are scored. Based on the scores of each of the candidate headings, a section heading for the semantically related section of the document is selected. The selected heading is then included in the table of contents for the section of the document. The process of identifying candidate headings, scoring candidates, and selecting the section heading is repeated for other semantically related sections of the document.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a network environment that includes a knowledge manager that utilizes a knowledge base;

FIG. 2 is a block diagram of a processor and components of an information handling system such as those shown in FIG. 1;

FIG. 3 is a component diagram depicting a table of contents generator that utilizes a knowledge manager, such as the knowledge manager introduced in FIG. 1;

FIG. 4 is a depiction of a flowchart showing the logic performed by an automatic table of contents generator acting on unformatted text;

FIG. 5 is a depiction of a flowchart showing the logic performed the table of contents generator routine that identifies potential section headings;

FIG. 6 is a depiction of a flowchart showing the logic performed the table of contents generator routine that identifies potential span and level/depth of section headings;

FIG. 7 is a depiction of a flowchart showing the logic performed the table of contents generator routine that identifies potential level/depth of heading candidates;

FIG. 8 is a depiction of a flowchart showing the logic performed the table of contents generator routine that calculates heading scores and derives a table of contents; and

FIG. 9 is a depiction of a flowchart showing the logic performed the table of contents generator routine that visits heading candidates that are at a current level that is being processed.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer, server, or cluster of servers. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

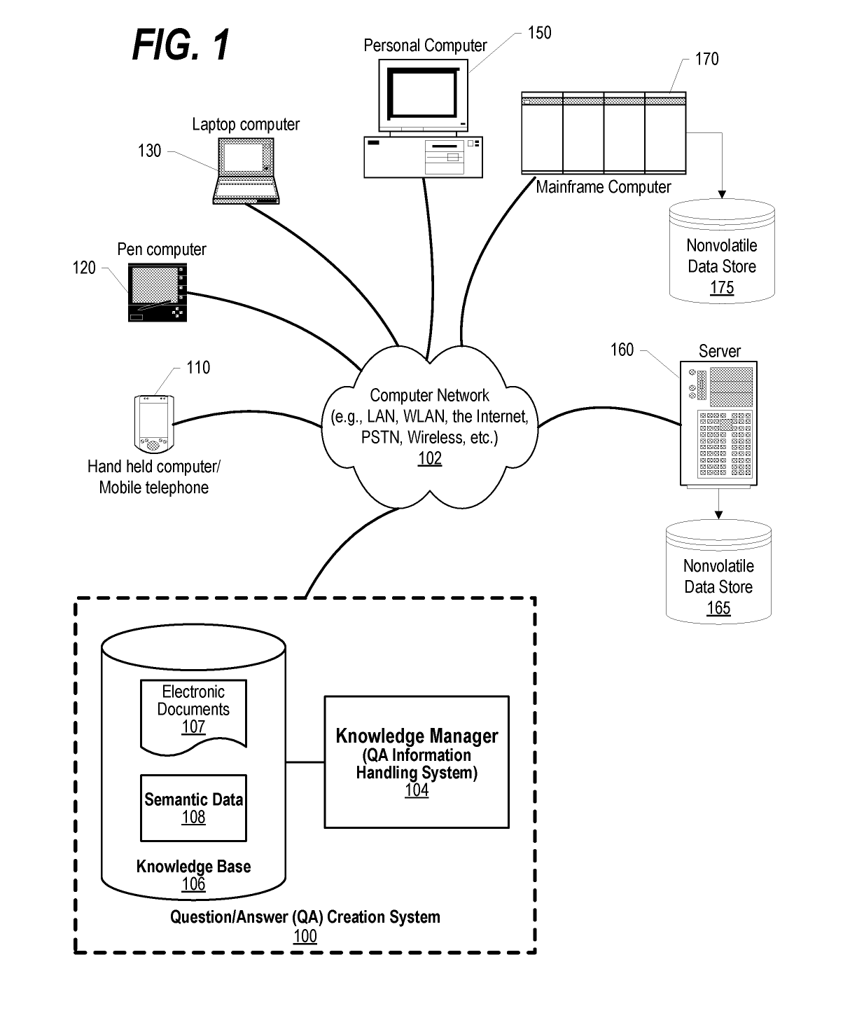

FIG. 1 depicts a schematic diagram of one illustrative embodiment of a question/answer creation (QA) system 100 in a computer network 102. One example of a question/answer generation which may be used in conjunction with the principles described herein is described in U.S. Patent Application Publication No. 2011/0125734, which is herein incorporated by reference in its entirety. Question-answer (QA) system 100 may include a computing device 104 (comprising one or more processors and one or more memories, and potentially any other computing device elements generally known in the art including buses, storage devices, communication interfaces, and the like) connected to the computer network 102. The network 102 may include multiple computing devices 104 in communication with each other and with other devices or components via one or more wired and/or wireless data communication links, where each communication link may comprise one or more of wires, routers, switches, transmitters, receivers, or the like. QA system 100 and network 102 may enable question/answer generation functionality for one or more content users. Other embodiments of QA system 100 may be used with components, systems, sub-systems, and/or devices other than those that are depicted herein.

QA system 100 may be configured to receive inputs from various sources. For example, QA system 100 may receive input from the network 102, a corpus of electronic documents 106 or other data, a content creator 108, content users, and other possible sources of input. In one embodiment, some or all of the inputs to QA system 100 may be routed through the network 102. The various computing devices 104 on the network 102 may include access points for content creators and content users. Some of the computing devices 104 may include devices for a database storing the corpus of data. The network 102 may include local network connections and remote connections in various embodiments, such that QA system 100 may operate in environments of any size, including local and global, e.g., the Internet. Additionally, knowledge manager 100 serves as a front-end system that can make available a variety of knowledge extracted from or represented in documents, network-accessible sources and/or structured data sources. In this manner, some processes populate the knowledge manager with the knowledge manager also including input interfaces to receive knowledge requests and respond accordingly.

In one embodiment, the content creator creates content in a document 106 for use as part of a corpus of data with QA system 100. The document 106 may include any file, text, article, or source of data for use in QA system 100. Content users may access QA system 100 via a network connection or an Internet connection to the network 102, and may input questions to QA system 100 that may be answered by the content in the corpus of data. In one embodiment, the process sends well-formed questions (e.g., natural language questions, etc.) to one or more components of the QA system. QA system 100 may interpret the question and provide a response to the content user containing one or more answers to the question. In some embodiments, QA system 100 may provide a response to users in a ranked list of answers.

In some illustrative embodiments, QA system 100 may be the IBM Watson™ QA system available from International Business Machines Corporation of Armonk, N.Y., which is augmented with the mechanisms of the illustrative embodiments described hereafter. The IBM Watson™ knowledge manager system may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The IBM Watson™ QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e. candidate answer, is inferred by the question. This process may be repeated for each of the candidate answers until the IBM Watson™ QA system identifies candidate answers that surface as being significantly stronger than others and thus, generates a final answer, or ranked set of answers, for the input question. More information about the IBM Watson™ QA system may be obtained, for example, from the IBM Corporation website, IBM Redbooks, and the like. For example, information about the IBM Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

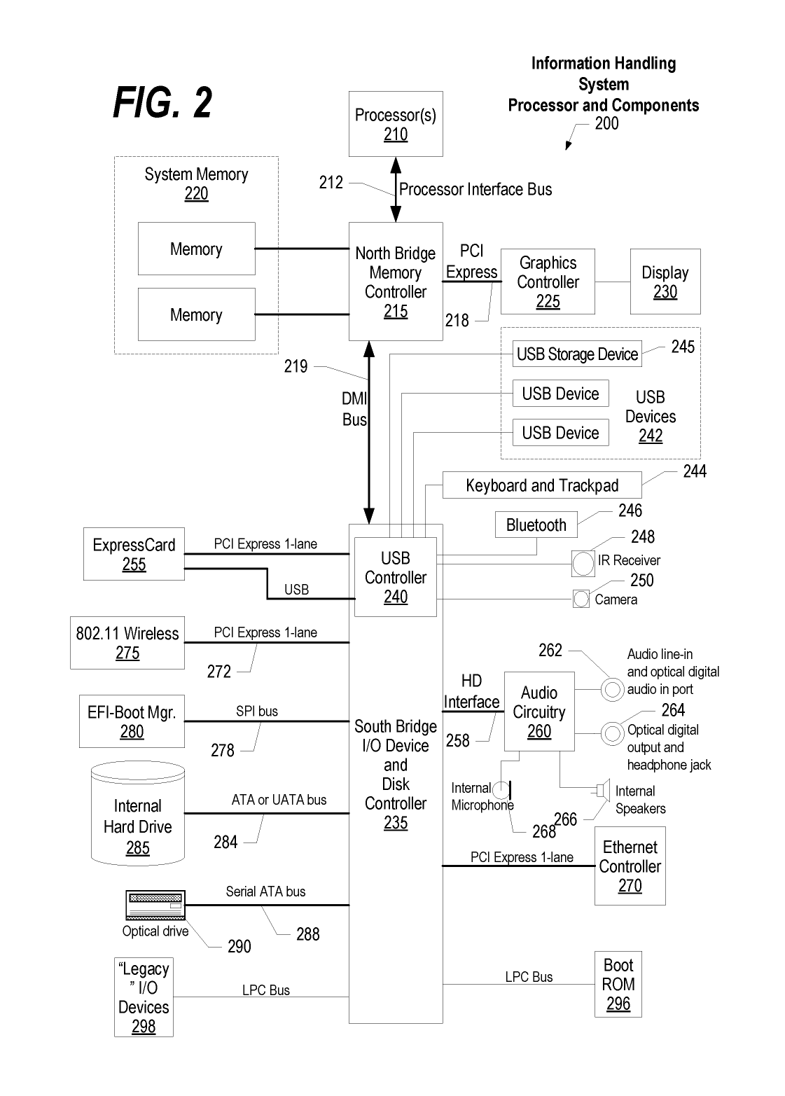

Types of information handling systems that can utilize QA system 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. As shown, the various information handling systems can be networked together using computer network 100. Types of computer network 102 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 1 depicts separate nonvolatile data stores (server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, more particularly, a processor and common components, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219. In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. The LPC bus also connects Southbridge 235 to Trusted Platform Module (TPM) 295. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, modems, network cards, ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, etcetera.

Wireless Local Area Network (LAN) device 275 connects to Southbridge 235 via the PCI or PCI Express bus 272. LAN device 275 typically implements one of the IEEE 0.802.11 standards of over-the-air modulation techniques that all use the same protocol to wireless communicate between information handling system 200 and another computer system or device. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

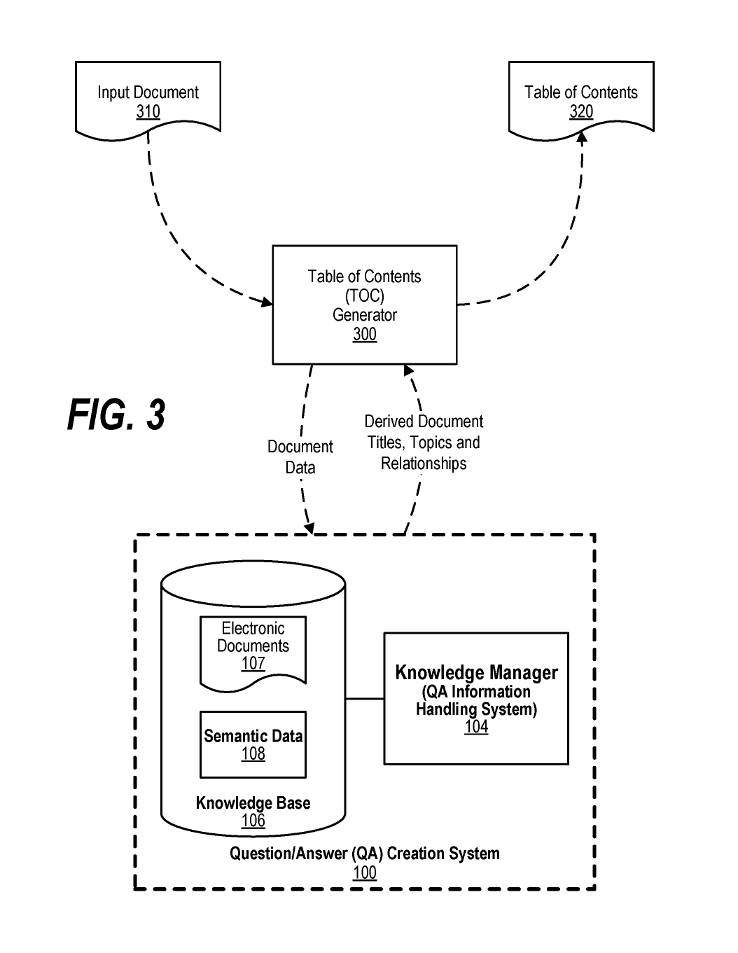

FIGS. 3-9 depict an approach that can be executed on an information handling system, to generate a table of contents for an unstructured document using a knowledge manager, such as knowledge manager 104 shown in FIG. 1. The methodology semantically understands the meaning of the document content, analyzing it holistically from end to end and then determines which portions of the document qualify to be determined as either a headline, title, section heading, sub-section, and so on, thus enabling in the generation of a table of contents. The approach disclosed herein leverages these portions as candidates for the table of contents and generate a table of contents accordingly. Furthermore, this approach is able to score the table of contents candidates accordingly, so that each item in the table of contents that is either a main heading or a sub-heading is the appropriate candidate type of the table of contents. In this manner, the approach is capable of understanding the semantic meaning of the document content by analyzing the parts of the document such as paragraphs, sentences, and even individual words. Consequently, given a document that does not include formatting information, the methodology is capable of determining the table of contents candidates automatically and assigning scores to them. Furthermore, this methodology does not require any indication within the document to generate the table of contents. The system discussed above is further described in FIGS. 3-9 and accompanying detailed descriptions, discussed below, which provide further details related to one or more embodiments that provide an approach for generating a table of contents for unstructured documents.

FIG. 3 is a component diagram depicting a table of contents generator that utilizes a knowledge manager, such as the knowledge manager introduced in FIG. 1. Table of contents generator 300 is a system capable of generating a table of contents corresponding to an unformatted document, such as input document 310. Input document 310 could be the output of optical character reader (OCR) scanned documents, call center chat transcripts, meeting notes, or any other documents that do not have any text formatting indications embedded inside the source content. Table of contents generator 300 semantically analyzes input document 310 to identify semantic relationships of proximate elements of the document. The table of contents generator identifies a number of candidate, or possible, headings that correspond to a semantically related section of the document. Each of the candidate headings is scored by the table of contents generator and the section headings are selected based on the scores of each of the candidate headings. These headings are then included in table of contents 320 for the section of the document. The process repeatedly identifies, scores, selects, and includes other sections in the table of contents until the entire document is processed. In order to derive document headings, topics, and relationships between sections of the input document, table of contents generator 300 transmits document data, such as phrases, sentences, etc., to question/answer (QA) creation system 100 that includes knowledge manager 104 that has a corpus of electronic documents 107 and semantic data 108 to identify the most likely document sections, headings, and topics to include in the table of contents.

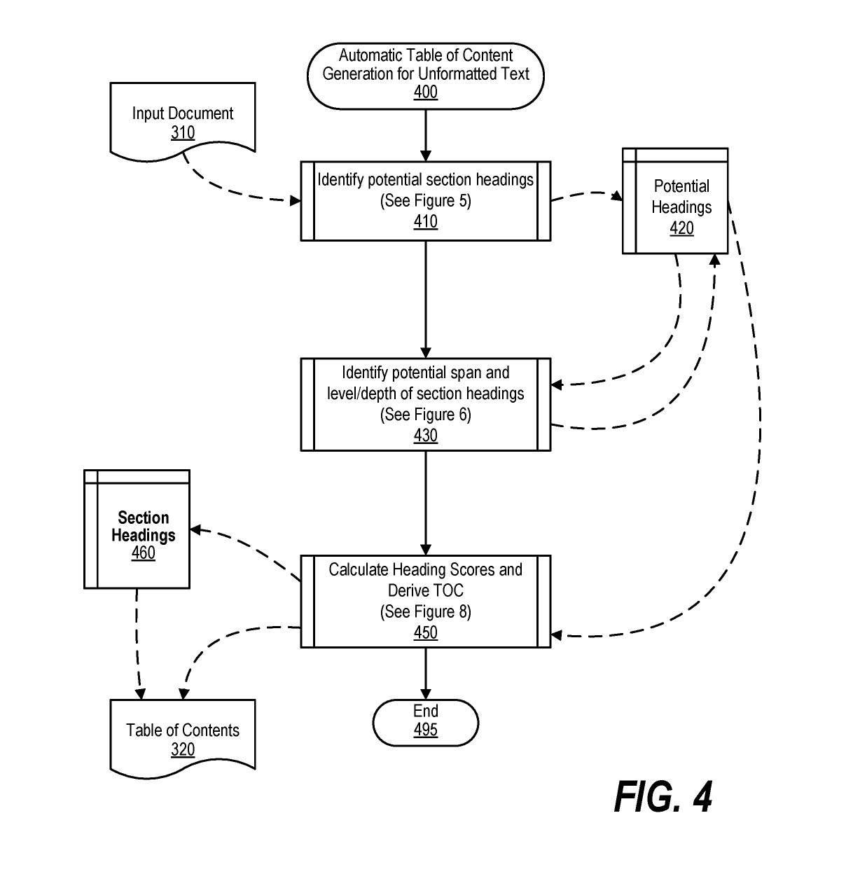

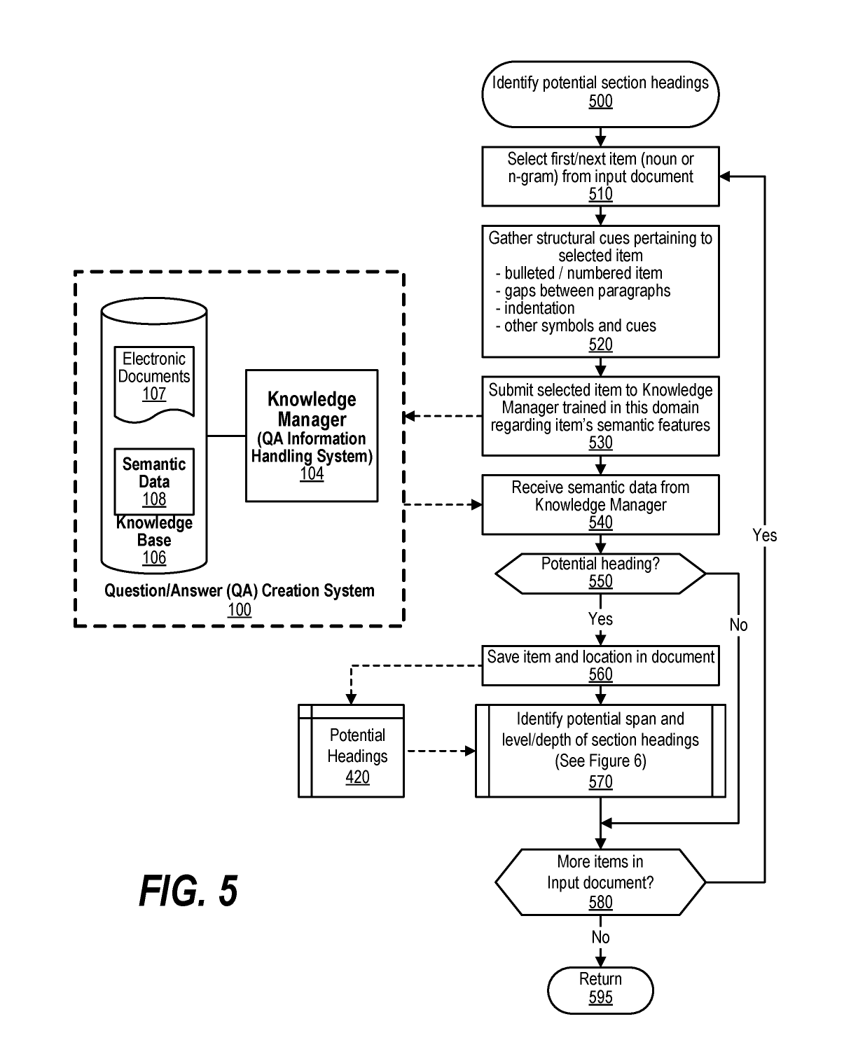

FIG. 4 is a depiction of a flowchart showing the logic performed by an automatic table of contents generator acting on unformatted text. Processing commences at 400 whereupon, at predefined process 410, the process identifies potential section headings that are included in input document 310 (see FIG. 5 and corresponding text for processing details). The potential headings are stored in memory area 420.

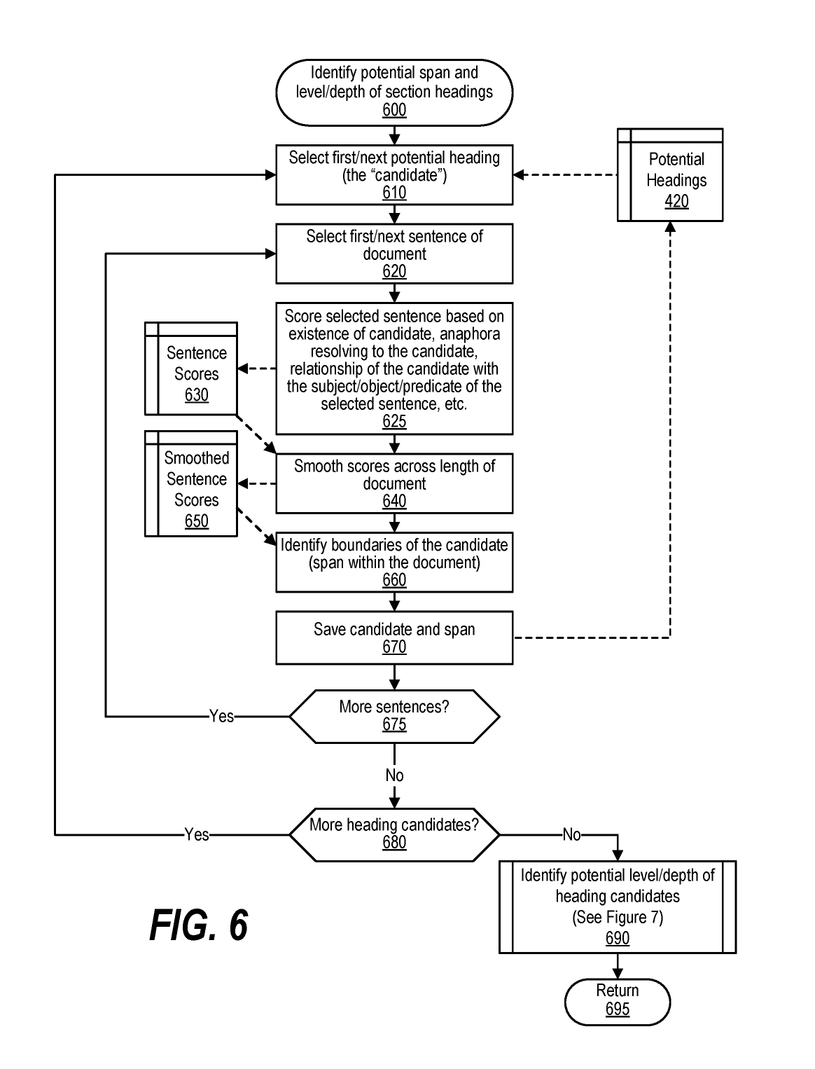

At predefined process 430, the process identifies the potential span and level/depth of the section headings that were identified in predefined process 410 and stored in memory area 420 (see FIG. 6 and corresponding text for processing details). Predefined process updates memory area 420 with the identified potential span and level/depth of section headings.

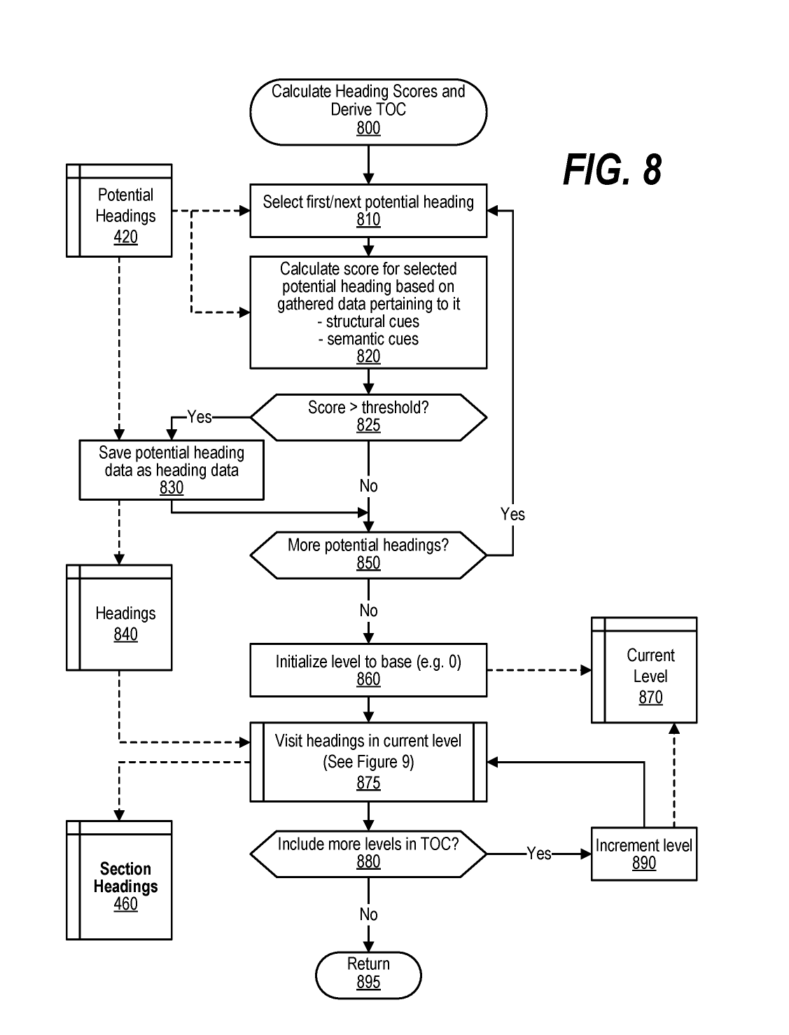

At predefined process 450, the process calculates heading scores for the potential headings and derives table of contents 320 (see FIG. 8 and corresponding text for processing details). The potential headings that receive the highest scores are stored in section headings memory area 460 and these section headings are used in table of contents 320. Processing of the table of contents then ends at 495.

FIG. 5 is a depiction of a flowchart showing the logic performed the table of contents generator routine that identifies potential section headings. Processing commences at 500 whereupon, at step 510, the process selects the first element of the document. As shown, the element might be a noun or an “n-gram” with an n-gram being a contiguous sequence of n items from a given sequence of text in the document. The items in the n-gram can be phonemes, syllables, letters, words or base pairs according to the application.

At step 520, the process gathers structural cues that pertain to the selected item (e.g., noun, n-gram, etc.). Structural cues can include cues such as whether the item is a bulleted or numbered item, whether there are gaps between lines or paragraphs, indentation of lines or paragraphs, and other symbols and structural cues. At step 530, the selected item is submitted to knowledge manager 104 that is, in one embodiment, trained in the domain regarding the item's semantic features. For example, if the input document is a medical transcript, then the domain might be a medical domain with the corpus including other medical transcripts and documents. At step 530, the process receives semantic data back from knowledge manager 104.

A decision is made by the process, based on the received semantic data, as to whether the selected item is a potential heading in the document (decision 550). If the selected item is a potential heading, then decision 550 branches to the “yes” branch whereupon, at step 560, the selected item is saved as a potential heading in memory area 420 along with the location of the selected item in the input document. At predefined process 570, the process identifies the potential span and level/depth of the potential section heading (see FIG. 6 and corresponding text for processing details). Returning to decision 550, if the selected item is not a potential heading, then decision 550 branches to the “no” branch bypassing step 560 and predefined process 570.

A decision is made by the process as to whether there are more items in the input document to select and process (decision 580). If there are more items to select and process, then decision 580 branches to the “yes” branch which loops back to select and process the next item in the input document as described above. This looping continues until all of the items in the input document have been processed, at which point decision 595 branches to the “no” branch whereupon processing returns to the calling routine (see FIG. 4) at 595.

FIG. 6 is a depiction of a flowchart showing the logic performed the table of contents generator routine that identifies potential span and level/depth of section headings. Processing commences at 600 whereupon, at step 610, the process selects the first potential heading from potential headings memory area 420. The selected potential heading is referred to as the candidate heading (or sub-heading if sub-headings are being identified). At step 620, the process selects the first sentence of the document. At step 625, the process scores the selected sentence based on the existence of the selected candidate heading, an anaphora resolving to the selected candidate heading, the relationship between the candidate heading with the subject/object/predicate of the selected sentence, and the like. The score for the selected sentence is stored in memory area 630. At step 640, the sentence scores are smoothed across the entire length of the document, with the smoothed scores being stored in memory area 650. At step 660, the process identifies boundaries of the candidate heading (the span of the candidate heading's section within the document). At step 670, the candidate heading and its identified span are saved in potential headings data store 420, updating the candidate heading data previously stored in the memory area.

A decision is made by the process as to whether there are more sentences in the document to process (decision 675). If there are more sentences in the document to process, then decision 675 branches to the “yes” branch which loops back to select and process the next sentence as described above. This looping continues until there are no more sentences to process, at which point decision 675 branches to the “no” branch.

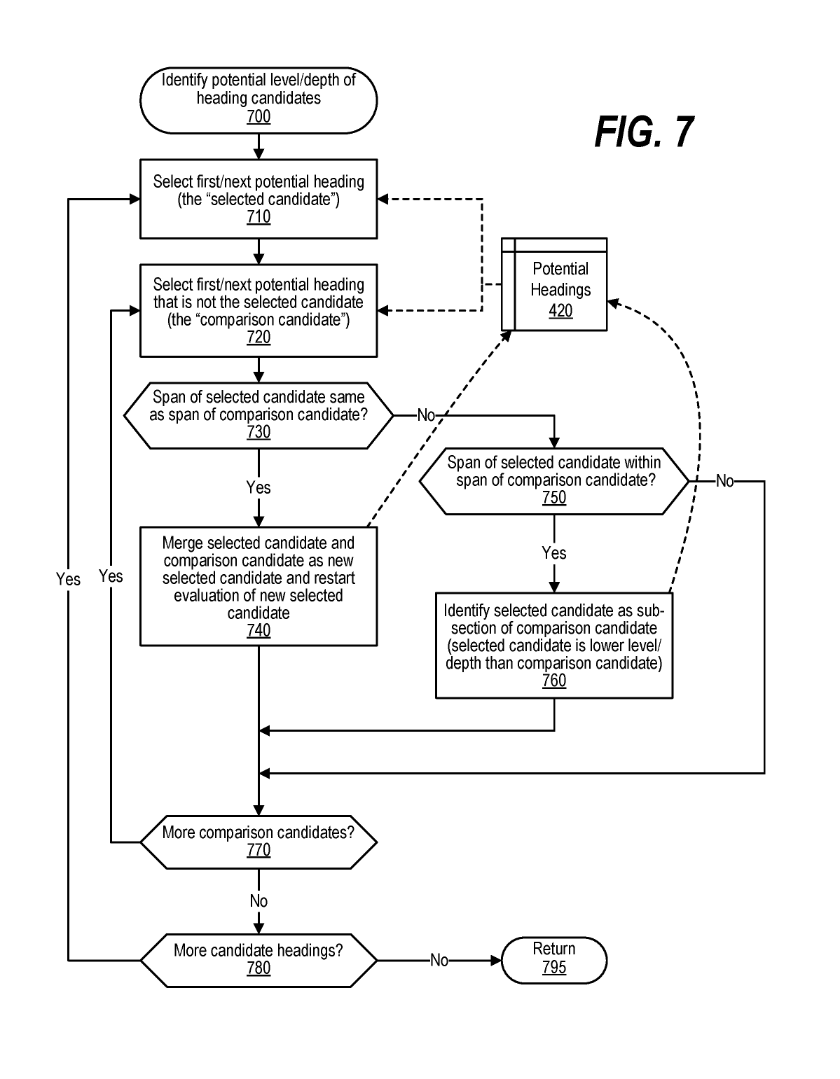

A decision is made by the process as to whether there are more candidate headings to process from memory area 420 (decision 680). If there are more candidate headings to process, then decision 680 branches to the “yes” branch which loops back to select and process the next candidate heading as described above. This looping continues until there are no more candidate headings to process, at which point decision 680 branches to the “no” branch whereupon, at predefined process 690, the process identifies the potential level and depth of the candidate headings (see FIG. 7 and corresponding text for processing details). Processing then returns to the calling routine (see FIG. 6) at 695.

FIG. 7 is a depiction of a flowchart showing the logic performed the table of contents generator routine that identifies potential level/depth of heading candidates. Processing commences at 700 whereupon, at step 710, the process selects the first candidate heading from memory area 420. At step 720, the process selects the first comparison candidate. The comparison candidate is another candidate heading that is not the selected candidate heading.

A decision is made by the process as to whether the span of the selected candidate heading is the same as the span of the comparison candidate (decision 730). If the span of the selected candidate heading is the same as the span of the comparison candidate, then decision 730 branches to the “yes” branch whereupon, at step 740, the process merges the selected candidate heading and the comparison candidate as a new selected candidate heading and the process restarts the evaluation of this new selected candidate. On the other hand, if the span of the selected candidate heading is not the same as the span of the comparison candidate, then decision 730 branches to the “no” branch whereupon a decision is made by the process as to whether the span of the selected candidate heading is contained within the span of the comparison candidate (decision 750). If the span of the selected candidate heading is contained within the span of the comparison candidate, then decision 750 branches to the “yes” branch whereupon, at step 760, the process identifies the selected candidate heading as being sub-heading of the comparison candidate, with the selected candidate heading being at a lower level/depth than the comparison candidate. On the other hand, if the span of the selected candidate heading is not contained within the span of the comparison candidate, then decision 750 branches to the “no” branch bypassing step 760.

A decision is made by the process as to whether there are more comparison candidates to process and compare to the selected candidate heading as described above (decision 770). If there are more comparison candidates to process, then decision 770 branches to the “yes” branch which loops back to step 720 to select the next comparison candidate and process the next comparison candidate as described above. This looping continues until there are no more comparison candidates to process, at which point decision 770 branches to the “no” branch. A decision is made by the process as to whether there are more candidate headings to process (decision 780). If there are more candidate headings to process, then decision 780 branches to the “yes” branch which loops back to step 710 to select the next candidate heading and process it as described above. This looping continues until all of the candidate headings stored in memory area 420 have been processed, at which point decision 780 branches to the “no” branch and processing returns to the calling routine (see FIG. 6) at 795.

FIG. 8 is a depiction of a flowchart showing the logic performed the table of contents generator routine that calculates heading scores and derives a table of contents. Processing commences at 800 whereupon, at step 810, the process selects the first candidate heading from memory area 420. At step 820, the process calculates a score for the selected candidate heading based on structural cue data and semantic cue data gathered for the selected candidate heading. A decision is made by the process as to whether the score calculated for the selected candidate heading exceeds a given threshold (decision 825). If the score exceeds the threshold, then decision 825 branches to the “yes” branch whereupon, at step 830, the process saves the candidate heading as a heading. The heading data (e.g., heading text, page number, etc.) is stored in headings data store 840. On the other hand, if the score calculated for the selected candidate heading does not exceed the threshold, then decision 825 branches to the “no” branch bypassing step 830 with the candidate heading not being included as a potential heading that might appear in the table of contents.

A decision is made by the process as to whether there are more candidate headings to process (decision 850). If there are more candidate headings to process, then decision 850 branches to the “yes” branch which loops back to step 810 to select the next candidate heading from memory area 420 and process the candidate heading as described above with a decision ultimately being made as to whether to include the candidate heading as a potential heading that might be included in the table of contents. This looping continues until all candidate headings have been processed, at which point decision 850 branches to the “no” branch for further processing.

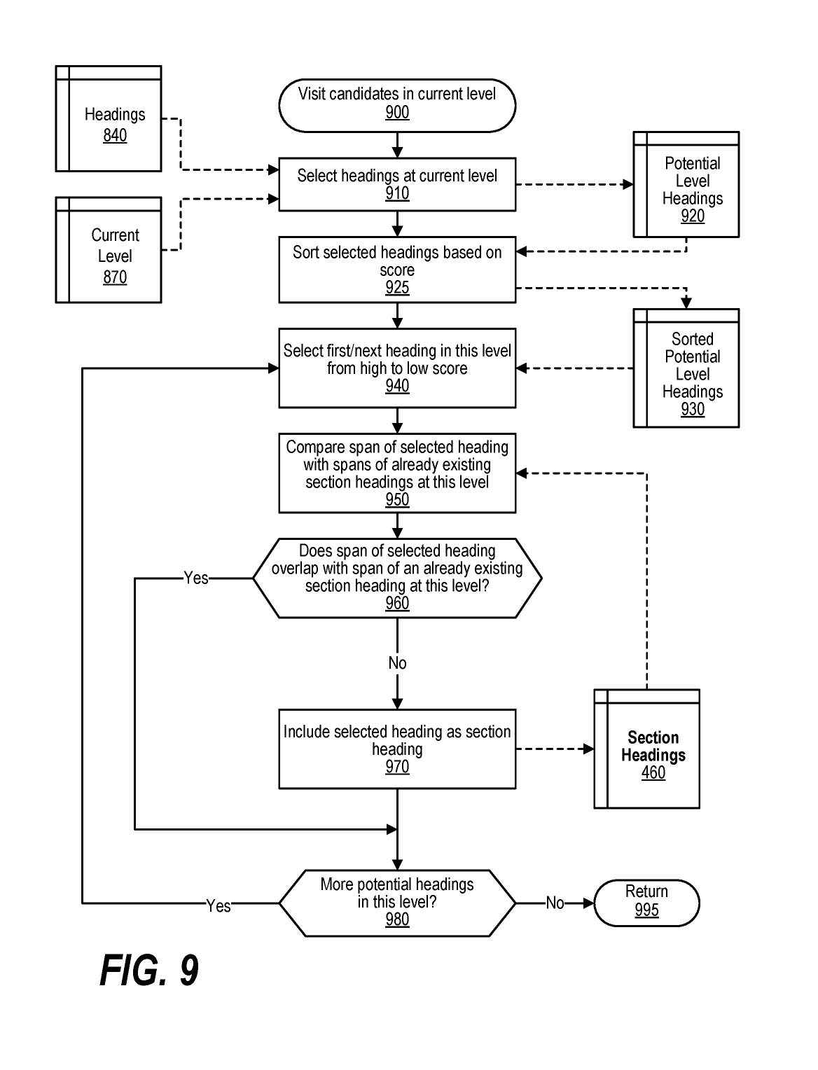

At step 860, the process initializes the current level to a base level (e.g., to zero, etc.). The current level is stored in memory area 870. At predefined process 875, the process visits each of the headings in the current level (see FIG. 9 and corresponding text for processing details). The result of visiting headings at the current level by predefined process 875 are section headings that will appear in the table of contents and which are stored in memory area 460. After predefined process has visited the headings at the current level, a decision is made by the process as to whether to include additional levels (sub-headings) in the table of contents (decision 880). In one embodiment, the number of sub-headings is a configurable value so the user can specify the number of sub-headings (levels) desired in the table of contents. If more levels are to be included in the table of contents, then decision 880 branches to the “yes” branch whereupon, at step 890, the process increments the current heading level (e.g., to ‘one’, then ‘two’, etc.) and processing loops back to visit the headings in this heading level using predefined process 875. This looping continues until all of the levels to be included in the table of contents have been processed, at which point decision 880 branches to the “no” branch and processing returns to the calling routine (see FIG. 4) at 895.

FIG. 9 is a depiction of a flowchart showing the logic performed the table of contents generator routine that visits heading candidates that are at a current level that is being processed. Processing commences at 900 whereupon, at step 910, the process selects the headings from memory area 840 that are at the current heading level (e.g., zero, one, two, etc.) with the current heading level being retrieved from memory area 870. The headings at the current level are stored as potential level headings in memory area 920. At step 925, the process sorts the selected headings based upon the scores that were previously calculated for the headings and stored in memory area 840 based on the structural and semantic cues (see step 820 in FIG. 8). The sorted potential level headings are stored in memory area 930.

At step 940, the process the first potential level heading from memory area 930 with the first selected heading being the heading with the highest score. At step 950, the span of the selected heading is compared with the spans of those headings that have already been identified for this level (if any) with such spans of other headings being retrieved from section headings memory area 460.

A decision is made by the process as to whether the span of the selected heading overlaps with the span of an already existing section heading at this level (decision 960). If the span of the selected heading does not overlap with the span of a heading already included in memory area 460, then decision 960 branches to the “no” branch whereupon, at step 970, the selected heading is included as a section heading along with the page number and span of the selected heading. The selected heading, page number, and span data are stored in memory area 460.

A decision is made by the process as to whether there are more potential headings in the current level (decision 980). If there are more potential headings in the current level, then decision 980 branches to the “yes” branch which loops back to select and process the next potential level heading from sorted memory area 930. This looping continues until all of the potential headings from the current level have been processed, at which point decision 980 branches of the “no” branch and processing returns to the calling routine (see FIG. 8) at 995.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method, in an information handling system comprising a processor and a memory, of generating a table of contents pertaining to a document, the method comprising:
semantically analyzing the document to identify semantic relationships of proximate elements of the document;
identifying a plurality of candidate headings corresponding to a semantically related section of the document;
scoring the each of the plurality of candidate headings;
selecting, based on the scores of each of the plurality of candidate headings, a section heading for the semantically related section of the document;
including the selected heading in the table of contents for the section of the document; and
repeating the identifying, scoring, selecting, and including steps for other semantically related sections of the document.

2. The method of claim 1 further comprising:
identifying a plurality of candidate subheadings corresponding to a semantically related section of the document, wherein the plurality of candidate subheadings appear after a first of the selected headings included in the table of contents and before a second of the selected headings included in the table of contents;
scoring the each of the plurality of candidate subheadings;
selecting, based on the scores of each of the plurality of candidate headings, one or more of the plurality of candidate subheadings;
including the one or more selected subheadings as subheadings of the first of the selected headings in the table of contents; and
repeating the identifying, scoring, selecting, and including steps for selected headings included in the table of contents.

3. The method of claim 1 further comprising:
identifying a plurality of section boundaries that bound each of the semantically related sections in a manner that inhibits any section overlap between adjacent semantically related sections, wherein document content is in one of the semantically related sections.

4. The method of claim 3 wherein one or more of the section boundaries are identified based on a structural cue found in the document.

5. The method of claim 3 wherein the identification of section boundaries further comprises:
scoring each sentence in the document, wherein the score is based on the existence of the candidate heading pertaining to the sentence, an anaphora resolving to the candidate heading pertaining to the sentence, and a relationship of the candidate heading pertaining to the sentence and the sentence;
smoothing the scores across the entire document; and
identifying the section boundaries based upon the scores that correspond to adjacent sentences.

6. The method of claim 1 wherein the identifying of the plurality of candidate headings further comprises:
selecting an area of text in the document as a potential heading;
calculating a heading score pertaining to the selected area of text, wherein the heading score is calculated based on one or more structural cues included with the selected area of text and one or more semantic cues identified as a candidate heading in response to the calculated heading score being greater than a threshold; and
repeating the selecting and calculating steps for other areas of text included in the document.

7. The method of claim 1 further comprising:
identifying one or more of the plurality of candidate headings based on a knowledge manager corpus that has been trained with a domain of specific headings.
